(19) United States
(12) Patent Application Publication
(10) Pub. No.: US 2013/0042596 A1
(43) Pub. Date: Feb. 21, 2013

(54) Systems and Methods for Fabricating Hybrid Rocket Fuel Motor Fuel Grains

(71) Applicant: Jerome Keith Fuller, Lake Balboa, CA (US)

(72) Inventor: Jerome Keith Fuller, Lake Balboa, CA (US)

(73) Assignee: THE AEROSPACE CORPORATION, El Segundo, CA (US)

(21) Appl. No.: 13/564,445

(22) Filed: Aug. 1, 2012

Related U.S. Application Data
(60) Provisional application No. 61/514,175, filed on Aug. 2, 2011.

(51) Int. Cl. F02K 9/18; B05C 5/02; B05D 7/24

(52) U.S. Cl. 60/255; 427/402; 118/300; 118/320; 118/696

(57) ABSTRACT

Embodiments of the invention relate to systems and methods for fabricating hybrid rocket motor fuel grains. In one embodiment, a method for fabricating a rocket motor fuel grain can be provided. The method can include providing a platform operable to support a rocket motor fuel grain during fabrication. The method can also include disposing at least one fuel material onto the platform to form a material layer. Further, the method can include successively disposing additional fuel material onto the material layer in small amounts, wherein the rocket motor fuel grain is formed on the platform.

### RELATED APPLICATION

This application claims priority under 35 U.S.C. §119(e) to U.S. Provisional Patent Application No. 61/514,175, titled Systems and Methods for Fabricating Hybrid Rocket Motor Fuel Grains, filed on Aug. 2, 2011, the entire contents of which are hereby incorporated herein by reference.

### TECHNICAL FIELD

The invention relates generally to solid fuel hybrid rocket motors, and more particularly to systems and methods for fabricating hybrid rocket motor fuel grains.

### BACKGROUND

Hybrid rocket motors or “hybrid motors” have recently been given greater attention in the space community. Hybrid motors use reactants of different physical phase states, usually a solid fuel such as rubber and a liquid or gaseous oxidizer, such as nitrous oxide. Hybrid motors do not generally deliver the performance of liquid motors. However, hybrid motors are safer and simpler to build and to operate. Hybrid motors can have good performance but often have problems maintaining the proper oxidizer to fuel or “O/F” ratio over the duration of the burn. Hybrid motors also tend to be physically long along the rocket motor axis for the same reasons. Hybrid motors can have complicated systems for introducing the gaseous oxidizer portion at different positions length-wise in the fuel section.

Hybrid solid fuel bodies are generally two-dimensional shapes extruded into the third dimension, for a simple example, a thick-walled tube extruded along the length of the tube. Such a tube is characterized as having a center axial flow channel, usually called a “port.” The oxidizer is injected through an intake opening and into the solid fuel body and out through a nozzle as exhaust. The fuel is ignited by an igniter positioned proximal to where the oxidizer first contacts the fuel near the intake. The solid fuel bodies generally have a center elongated flow channel through which the oxidizer flows after ignition for ablating the fuel on the side walls of the center elongated flow channel. The fuel is burned on the internal surface effectively ablating, or “regressing” the solid fuel interior wall. As the fuel is burned, and port diameter increases, the combustion becomes oxidizer rich. If oxidizer-rich burning occurs, additional oxidizer must be carried and the efficiency of the system is typically poor. Complex fuel grain shapes are sometimes used to increase the amount of surface area in the elongated center flow channel, but sometimes at the risk of an unsupported section of fuel breaking off and plugging the nozzle, causing a catastrophic failure of the hybrid motor. As the fuel burns through the elongated center flow channel, the oxidizer burns the inside of the channel. The growing diameter of the elongated center flow channel changes the ratio between the oxidizer flowing in the channel and the exposed burning fuel on the side walls of the elongated center flow channel. The hybrid rocket motor suffers from changing oxidizer to fuel ratio. The oxidizer to fuel ratio becomes oxidizer rich and thereby wastes available oxidizer that could otherwise be used for more burning of the fuel.

Another problem that is associated with hybrid motors, at least for use in launch vehicles, is low regression rates, typically one third of that of composite solid propellants. Regression rate is the depth-wise rate at which the fuel is removed from the surface where burning occurs. This is a factor in the development of rocket engine thrust. A great amount of research has gone into replacing the solid rocket boosters on the Space Shuttle with hybrid motors only to show that hybrids suffer from low regression rates, which may make replacing large solid motors very difficult.

A problem associated with the fabrication of hybrid motors where paraffin wax is the fuel, is approximately 15% shrinkage as the liquid paraffin wax cools to a solid. Fuel grains, which are cast, can develop voids or bubbles. One method of alleviating this problem is to spin or otherwise rotate the fuel grain in a lathe-like apparatus so that the fuel is forced against the motor casing and a port naturally forms along the motor axis. This technique can limit the minimum port diameter and lends itself to a relatively simple round-shaped port, which is usually not compatible with the use of additives, particularly those with different densities than paraffin wax. Additives of a higher density than paraffin wax would be flung toward the motor casing rather than being evenly distributed throughout the fuel grain.

### SUMMARY

Embodiments of the invention can address some or all of the above needs. Certain embodiments of the invention can provide systems and methods for fabricating hybrid rocket motor fuel grains. Other embodiments can provide an apparatus such as a hybrid rocket motor fuel grain. In one embodiment, a method for fabricating a rocket motor fuel grain can be provided. The method can include providing a platform operable to support a rocket motor fuel grain during fabrication. The method can also include disposing at least one fuel material onto the platform to form a material layer. Further, the method can include successively disposing additional fuel material onto the material layer in small amounts, wherein the rocket motor fuel grain is formed on the platform, the rocket motor fuel grain comprising a three-dimensional port shape.

In one aspect of an embodiment, the method can further include providing at least one dispensing nozzle operable to dispense the one fuel material, and manipulating the at least one dispensing nozzle with respect to the platform.

In one aspect of an embodiment, the method can further include manipulating the platform in a longitudinal direction as additional fuel material is successively disposed onto the material layer.

In one aspect of an embodiment, the at least one dispensing nozzle can be manipulated in a lateral direction with respect to the platform as additional fuel material is successively disposed onto the material layer.

In one aspect of an embodiment, the platform can be rotated as additional fuel material is successively disposed onto the material layer.

In one aspect of an embodiment, the platform can be considered as one axis of a Cartesian coordinate system, where the one or more dispensers or at least one dispensing nozzle can be moved in the other two orthogonal axes. In yet another embodiment, a non-Cartesian robot, such as a hexapod may can be used with the dispensers and dispensing nozzle.

In one aspect of an embodiment, successively disposing additional fuel material onto the material layer in small amounts is controlled by a computer processor. In certain aspects of embodiments, since there is no bulk of material to cool and shrink and some or all shrinkage is limited to each layer, the net shape of the fuel grain can remain as designed.

In one aspect of an embodiment, the at least one dispensing nozzle can include a plurality of dispensing nozzles, wherein each of the plurality of dispensing nozzles is heated and controlled by a computer processor.

In one aspect of an embodiment, the at least one fuel material comprises paraffin wax, an additive, a mixture of a fuel and at least one additive, or a material that shrinks upon cooling.

In one aspect of an embodiment, the three-dimensional port shape can include one of the following: a helical shape, a concentric disk shape, a series of anteriorially linked disk shapes, a geometric shape with at least one undercut feature, a geometric shape with at least one overhang feature, or at least one non-longitudinal feature.

In one aspect of an embodiment, the at least one fuel material comprises at least one additive which may enhance burn rate, strength, opacity, fuel marking, fuel coloring, flame color, or which would provide a visible indication of burn progress.

In one embodiment, a system for fabricating a rocket motor fuel grain can be provided. The system can include a platform operable to support a rocket motor fuel grain during fabrication. The system can also include a dispenser operable to dispense at least one fuel material onto the platform to form a rocket motor fuel grain, and further operable to be manipulated with respect to the platform, wherein the at least one fuel material is dispensed onto the platform to form a material layer, and wherein additional fuel material is successively dispensed onto the material layer in small amounts, and the rocket motor fuel grain comprising a three-dimensional port shape.

In one aspect of an embodiment, the system can further include at least one fuel material source operable to provide the dispenser with the at least one fuel material.

In one aspect of an embodiment, the platform is further operable to be manipulated in a longitudinal direction as additional fuel material is successively disposed onto the material layer.

In one aspect of an embodiment, the dispenser can include at least one dispensing nozzle operable to be manipulated in a lateral direction with respect to the platform as additional fuel material is successively disposed onto the material layer.

In one aspect of an embodiment, the platform is operable to be rotated as additional fuel material is successively disposed onto the material layer.

In one aspect of an embodiment, the system can further include a computer processor operable to control dispensing the at least one fuel material onto the platform, and further operable to control dispensing additional fuel material onto the material layer in small amounts.

In one aspect of an embodiment, the dispenser can include a plurality of dispensing nozzles operable to be heated and controlled by the computer processor.

In one aspect of an embodiment, the system can further include at least one motor operable to control at least one of the platform or the dispenser.

In one aspect of an embodiment, the at least one fuel material can include paraffin wax, an additive, a mixture of a fuel and at least one additive, or a material that shrinks upon cooling.

In one aspect of an embodiment, the at least one fuel material can include a solid oxidizer, such as ammonium perchlorate or ammonium nitrate, or a High Energy Composite material such as cyclotrimethylenetrinitramine and may be combined with other propellants or with varying proportions of propellants in different regions of the fuel grain. This can form a solid rocket motor or a hybrid rocket motor where an amount of solid oxidizer is used to establish a specific pressure level or to expose burning surfaces in order to manipulate surface area.

In one aspect of an embodiment, the three-dimensional port shape can include one of the following: a helical shape, a concentric disk shape, a series of anteriorially linked disk shapes, a geometric shape with at least one undercut feature, a geometric shape with at least one overhang feature, or at least one non-longitudinal feature.

In one embodiment, an apparatus can be provided. The apparatus can include a at least one fuel material formed by dispensing the at least one fuel material onto the platform to form a material layer, and successively dispensing additional fuel material onto the material layer in small amounts, wherein at least one port shape is formed in the at least one fuel material, and at least one three-dimensional port shape formed by the at least one fuel material.

In one aspect of an embodiment, the at least one port shape can include at least one of the following: a helical shape, a concentric disk shape, a series of anteriorially linked disk shapes, a geometric shape with at least one undercut feature, a geometric shape with at least one overhang feature, or three-dimensional geometric shape with at least one non-longitudinal feature.

In one aspect of an embodiment, the at least one fuel material can include at least one of the following: paraffin wax, an additive, a mixture of a fuel and at least one additive, or a material that shrinks upon cooling.

Other systems, processes, apparatus, features, and aspects according to various embodiments of the invention will become apparent with respect to the remainder of this document.

### BRIEF DESCRIPTION OF DRAWINGS

Having thus described embodiments of the invention in general terms, reference will now be made to the accompanying drawings, which are not drawn to scale, and wherein:

FIG. 1 illustrates a functional block diagram of an example system according to one embodiment of the invention.

FIG. 2 illustrates an example system and apparatus according to certain embodiments of the invention.

FIG. 3 illustrates another example system and apparatus according to an embodiment of the invention.

FIG. 4 illustrates another example system and apparatus according to an embodiment of the invention.

FIG. 5 illustrates a flowchart of an example method according to one embodiment of the invention.

FIGS. 6-10 illustrate example apparatus according to certain embodiments of the invention.

### DETAILED DESCRIPTION OF EXEMPLARY EMBODIMENTS OF THE INVENTION

Embodiments of the invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention. Like numbers refer to like elements throughout.

As used herein, the term “fuel grain” can refer to relatively solid fuel body for a rocket motor.

As used herein, the term “port” can refer to a generally open space within a fuel body for a rocket motor.

As used herein, the term “fuel material” can refer to a fuel, an additive, an inhibitor, a mixture of fuel and another compatible substance, or any substance that can be mixed with any of the foregoing. In one exemplary embodiment, the fuel material can include a solid oxidizer, such as ammonium perchlorate or ammonium nitrate, or a High Energy Composite material such as cyclotrimethylenetrinitramine and may be combined with other propellants or with varying proportions of propellants in different regions of the fuel grain. This can form a solid rocket motor or a hybrid rocket motor where an amount of solid oxidizer is used to establish a specific pressure level or to expose burning surfaces in order to manipulate surface area.

Certain embodiments of the invention generally provide for systems and methods for fabricating hybrid rocket motor fuel grains. Certain embodiments of systems and methods described herein can provide apparatus such as fuel grains for hybrid rocket motors used for satellite propulsion and other small motors. Because a variety of different shapes can be made using various system and methods according to embodiments of the invention, relatively complex hybrid rocket motor fuel grains can be formed for relatively larger hybrid or composite rocket motors. Lower costs, increased sizes, and freedom of choice to use different fuel materials can result in using certain embodiments of the systems and methods described herein. Furthermore, technical effects by certain embodiments of the invention can result such as the creation or formation of relatively complex or three-dimensional port shapes within hybrid and/or composite rocket motor fuel grains. The relatively complex or three-dimensional port shapes may assist in increasing the effective length and/or surface area of the associated port shape to improve better fuel/air mixing or to increase turbulence within the port, increase oxidizer dwell time, improve propellant mass fraction, and minimize associated disruptions in the fuel flow and/or thrust provided in or by the hybrid and/or composite rocket motor fuel grains according to embodiments of the invention. One result of certain embodiments of the invention is increased thrust from fuel grains for hybrid rocket motors.

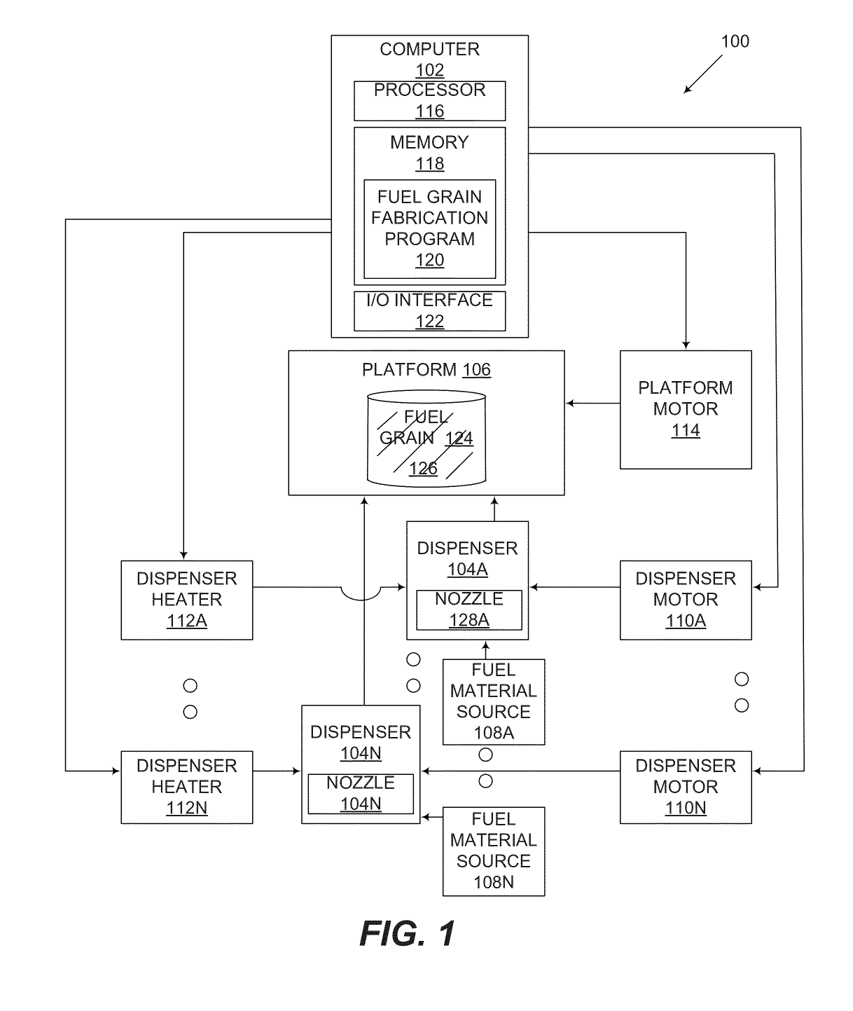

FIG. 1 illustrates an example system in accordance with an embodiment of the invention. In this example, the system can be a fuel grain fabrication system 100. The system 100 is shown with a computer 102 in communication with one or more dispensers 104A-104N and a platform 106. The one or more dispensers 104A-104N can operate in conjunction with one or more respective fuel material sources 108A-108N, dispenser motors 110A-110N, and dispenser heaters 112A-112N. The system 100 can also operate in conjunction with a platform motor 114. It will be appreciated that while the disclosure may in certain instances describe only multiple dispensers, fuel material sources, dispenser motors, and dispenser heaters, there may, in certain embodiments, be only a single dispenser with any number of fuel material sources, dispenser motors, and dispenser heaters without departing from example embodiments of the invention.

A computer 102 can include one or more processor-based devices capable of communicating with the other components of the system 100 via a signal, such as a wireless frequency signal or a direct wired communication signal. In at least one embodiment, more than one computer 102 can be in communication with respective components of the system 100 to transmit and receive communications between the components of the system 100. The processor 116 can execute computer-executable program instructions stored in a computer-readable medium or memory 118, such as a random access memory (“RAM”), read only memory (“ROM”), and/or a removable storage device, coupled to the processor 116. The computer 102 may operate on any operating application program including, but not limited to, Microsoft Windows®, Apple OSX™, Unix™, and Linux™. In one embodiment, the computer 102 may include computer executable program instructions stored in the memory 118 or processor 116 for processing one or more fuel grain fabrication instructions within the system 100. In one embodiment, a fuel grain fabrication application program 120 with one or more fuel grain fabrication instructions can be stored in memory 118 or the processor 116. In another embodiment, a fuel grain application program 120 or set of one or more fuel grain fabrication instructions can include rapid prototyping instructions, techniques, or associated methods. In yet another embodiment, a fuel grain application program 120 or set of one or more fuel grain fabrication instructions can include instructions for disposing fuel material onto a platform to form an initial material layer, and further instructions for successively disposing additional fuel material onto the initial material layer in small amounts, and in certain embodiments, to account for fuel material shrinkage. The I/O interface 122 can be one or more interfaces to facilitate communication with one or more other components of the system 100, such as, with the dispenser, dispenser heater, dispenser motor, platform, and platform motor. The computer 102 may also include any number of other external or internal devices such as a mouse, a CD-ROM, DVD, a keypad, a keyboard, a display, or other input or output devices. Suitable examples of a computer 102 may include mobile computers, handheld portable computers, digital assistants, personal digital assistants, cellular phones, mobile phones, smart phones, pagers, digital tablets, desktop computers, laptop computers, Internet appliances, and other processor-based devices.

Generally, the computer 102 can include a respective memory 118 and processor 116. The memory 118 can store data and information for subsequent retrieval. When needed, data or information such as computer-executable instructions stored in memory 118 may be transmitted to the processor 116 for execution and/or implementation. Suitable processors may comprise a microprocessor, an ASIC, and state machine. Example processors can be those provided by Intel Corporation (Santa Clara, Calif.), AMD Corporation (Sunnyvale, Calif.), and Motorola Corporation (Schaumburg, Ill.). Such processors comprise, or may be in communication with media, for example computer-readable media, which stores instructions that, when executed by the processor, cause the processor to perform the elements described herein. Embodiments of computer-readable media include, but are not limited to, an electronic, optical, magnetic, or other storage or transmission device capable of providing a processor, such as the processor 116, with computer-readable instructions. Other examples of suitable media include, but are not limited to, a floppy disk, CD-ROM, DVD, magnetic disk, memory chip, ROM, RAM, a configured processor, all optical media, all magnetic tape or other magnetic media, or any other medium from which a computer processor can read instructions. Also, various other forms of computer-readable media may transmit or carry instructions to a computer, including a router, private or public network, or other transmission device or channel, both wired and wireless. The instructions may comprise code from any computer-programming language, including, for example, C, C++, C#, Visual Basic, Java, Python, Perl, and JavaScript.

Generally, the platform 106 can be operable to support a fuel grain apparatus, such as 124. In one embodiment, the platform can include a relatively horizontal table that can be rotated in either or both directions, and can be elevated and/or lowered as needed. The platform 106 can be controlled by way of at least one platform motor 114, which may be operable to move the platform 106 in any desired direction, range, speed, or angle. In any instance, the fuel grain apparatus 124 is typically formed on the platform 106 by dispensing at least one fuel material, such as paraffin wax, hydroxyl terminated polybutadiene (HTPB), a hybrid rocket motor fuel, a composite solid rocket motor fuel, a material that shrinks upon cooling, or any combination thereof onto the platform 106. In other embodiments, other fuel materials or combinations of fuel materials can be used to form a fuel grain apparatus including, but not limited to, a hybrid rocket motor fuel, or a composite solid rocket motor fuel. This can form a solid rocket motor or a hybrid rocket motor where an amount of solid oxidizer is used to establish a specific pressure level or to expose burning surfaces in order to manipulate surface area.

In one aspect of an embodiment, a fuel material can include any number of the following: a support-type material, a filler-type material, an additive, an inhibitor, or a structural-type material. In one aspect of an embodiment, the at least one fuel material can include a solid oxidizer, such as ammonium perchlorate or ammonium nitrate, or a High Energy Composite material such as cyclotrimethylenetrinitramine and may be combined with other propellants or with varying proportions of propellants in different regions of the fuel grain. This can form a solid rocket motor or a hybrid rocket motor where an amount of solid oxidizer is used to establish a specific pressure level or to expose burning surfaces in order to manipulate surface area.

In general, a support-type material can be a material operable to support a rocket fuel grain apparatus shape during formation of the apparatus. One suitable example of a support-type material is a soluble wax, which in certain instances may be soluble in alcohol, and can be dissolved away when needed. Another example of a support-type material is a wax or the soluble wax discussed above that can be melted away when no longer needed. Typically, a filler-type material can be a material that can facilitate forming a rocket fuel grain apparatus shape, and subsequently can be removed. One suitable example of a filler-type material is polyethylene. Generally, an additive can be a material operable to control the regression rate of one or more other fuel materials, such as paraffin wax. One suitable example of an additive is lithium aluminum hydride (LiAlH). Typically, an inhibitor can be a material operable to reduce the amount of another fuel material. One suitable example of an inhibitor is a mixture of paraffin wax and clay or microspheres made from glass bubbles. While the clay or microspheres can be mixed with the paraffin wax, the clay or microspheres function as an inhibitor since these materials, when mixed with a paraffin wax or other fuel material, can increase the volume of the paraffin wax or fuel material, used in a predefined area within a rocket fuel grain apparatus. Finally, a structural-type material can be a material operable to form the rocket fuel grain apparatus shape, and may be a fuel which contributes to burning the entire rocket fuel grain apparatus. One suitable structural-type material is a paraffin wax.

In one aspect of an embodiment, a fuel material can include at least one additive which may enhance or increase the regression or burn rate, strength, opacity, fuel marking, fuel coloring, flame color, or which would provide a visible indication of burn progress.

In one aspect of an embodiment, a fuel material can include one or more oxidizers. In one aspect of an embodiment, the at least one fuel material can include a solid oxidizer, such as ammonium perchlorate or ammonium nitrate, or a High Energy Composite material such as cyclotrimethylenetrinitramine and may be combined with other propellants or with varying proportions of propellants in different regions of the fuel grain. This can form a solid rocket motor or a hybrid rocket motor where an amount of solid oxidizer is used to establish a specific pressure level or to expose burning surfaces in order to manipulate surface area.

In one embodiment, a fuel grain fabrication system, such as 100, can switch between fuel material sources 108A-108N and/or associated dispensers 104A-104N and/or nozzles 128A-128N to dispense one or more fuel materials on a platform, such as 106, to form a fuel grain apparatus, such as 124, with at least one three-dimensional port shape, such as 126.

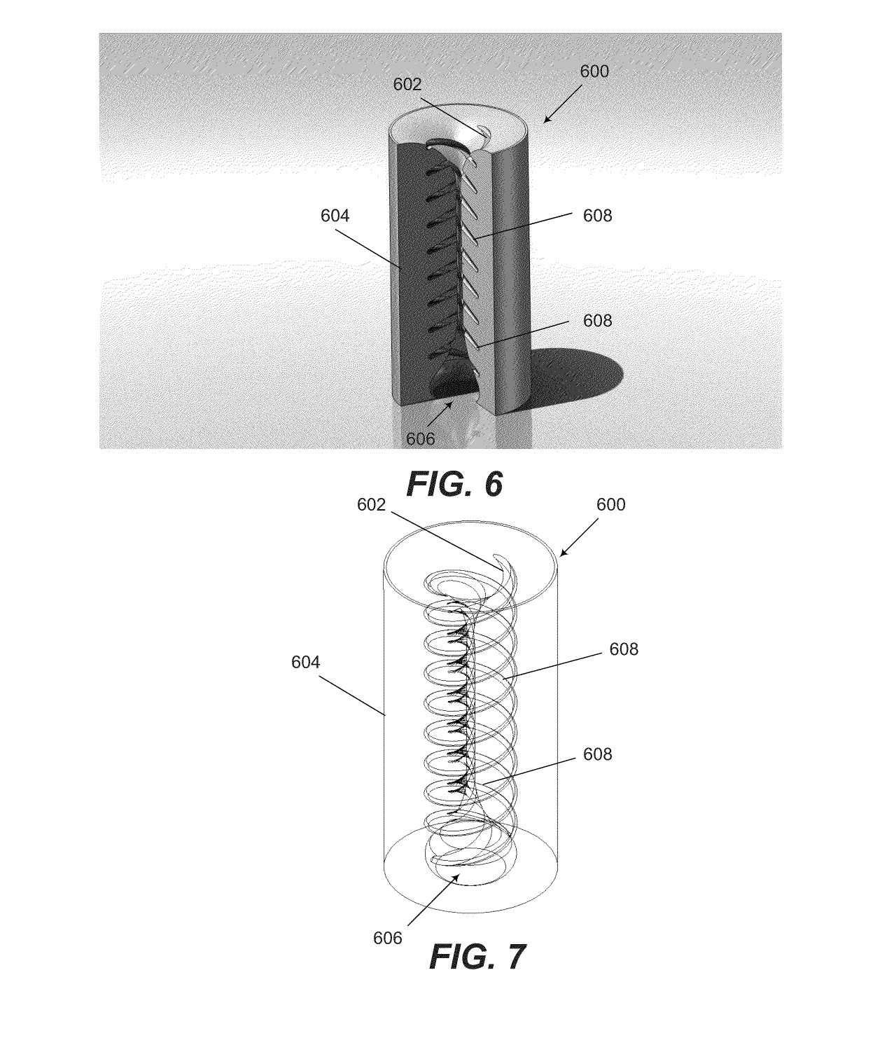

Relatively complex or three-dimensional port shapes can be formed in the fuel grain apparatus 124 using certain embodiments of the fuel grain fabrication system 100. These types of port shapes can facilitate improved mixing of the fuel, oxidizer, and any other additives while the fuel is being burned since these types of port shapes can have increased surface area over conventional port shapes. Certain types of port shapes can also be formed to facilitate control over the regression rate, such as slowing or increasing the rate, while other port shapes may decrease or increase the turbulence during burning of the fuel. Ultimately, improved efficiency in mixing and burning the fuel can be achieved, which can lead to improved thrust from the rocket motor fuel grain apparatus. Using systems and methods in accordance with embodiments of the invention, such as fuel grain fabrication system 100, a fuel grain apparatus 124 can be shaped with any desired three dimensional shape or configuration including a desired three dimensional port shape 126 within the fuel grain apparatus 124. In certain embodiments, a desired three-dimensional port shape can include at least one non-longitudinal feature. In other embodiments, a desired three dimensional port shape can include, but is not limited to, at least one of the following: a helical shape, a concentric disk shape, a series of anteriorially linked disk shapes, a geometric shape with at least one undercut feature, a geometric shape with at least one overhang feature, or at least one non-longitudinal feature. Example complex or three-dimensional port shapes for a fuel grain apparatus in accordance with certain embodiments of the invention are shown and described with respect to FIGS. 6-10 below.

In one aspect of an embodiment, a fuel grain apparatus with a geometric shape having at least one undercut or overhang feature can be formed, wherein the at least one undercut or overhang feature can contribute or otherwise generate turbulence in the associated port to assist with mixing the fuel material and any other substances during fuel grain regression.

Furthermore, using certain embodiments of the fuel grain fabrication system 100, various fuel materials of different or varying specific weights and/or densities, including fuels, additives, fuel materials, and mixtures of fuels, additives, and fuel materials can be dispensed and formed into a fuel grain apparatus, such as 124, in accordance with embodiments of the invention. In one exemplary embodiment, the fuel material can include a solid oxidizer, such as ammonium perchlorate or ammonium nitrate, or a High Energy Composite material such as cyclotrimethylenetrinitramine and may be combined with other propellants or with varying proportions of propellants in different regions of the fuel grain. This can form a solid rocket motor or a hybrid rocket motor where an amount of solid oxidizer is used to establish a specific pressure level or to expose burning surfaces in order to manipulate surface area. In this manner, one could form a fuel grain apparatus with relatively even distributions of one or more certain fuels, additives, fuel materials, or mixtures of fuels, additives, and fuel materials in each layer of the fuel grain apparatus.

Furthermore, using certain embodiments of the fuel grain fabrication system 100, various fuel materials of different or varying specific weights and/or densities, including fuels, additives, fuel materials, and mixtures of fuels, additives, and fuel materials can be dispensed simultaneously and formed into a fuel grain apparatus, such as 124, in accordance with embodiments of the invention. In this manner, one could form a fuel grain apparatus and differentiate the fuel grain surface with another material to facilitate sticking or adhesion to a fuel motor casing. For example, a fuel material layer can be formed in a fuel grain apparatus, such as 124, that facilitates sticking or adhesion of a fuel material to an outer shell or casing around a portion of the fuel grain apparatus. In another example, the outer shape of a fuel material layer in fuel grain apparatus, such as 124, could be formed with a texture which forms an interface against an adjacent fuel material layer. Using the textured layer between adjacent fuel materials and/or fuel material layers can minimize or prevent stripping or peeling of fuel material layers from a fuel motor casing around a portion of the fuel grain apparatus.

Generally, the one or more dispensers 104A-104N can be any number of devices in communication with at least one fuel material source, such as 108A. Each dispenser such as 104A may have one or more associated nozzles, such as 128A, which may operate in conjunction with a respective dispenser motor 110A, and dispenser heater 112A to control the heating and/or cooling, and dispensing of at least one fuel material from the fuel material source 108A with respect to the platform 106. In one embodiment, one dispenser such as 104A can utilize rapid prototyping instructions, techniques, or similar methods to dispense at least one fuel material such as paraffin wax onto or with respect to the platform to form the fuel grain apparatus 124 with a desired complex or three-dimensional port shape 126. In another embodiment, one or more dispensers 104A-104N can include any number of respective dispenser motors 110A-110N, dispenser heaters 112A-112N, and associated nozzles 132A-132N to dispense relatively small quantities of at least one fuel material from any number of respective fuel material sources 108A-108N onto or with respect to the platform 106 to form a desired shape, pattern, geometry, such as a relatively complex or three-dimensional shape, or otherwise desired port shape 126 for a fuel grain apparatus 124 and, in certain embodiments, to account for any fuel material shrinkage. In any instance, each nozzle such as 128A can be respectively heated and/or cooled by a dispenser heater such as 112A and controlled by a dispenser motor such as 110A and/or associated dispenser such as 104A coordinated by a computer processor such as 116.

In one aspect of an embodiment, one or more dispensers can include a dispenser tip with an associated heated dispenser block. The heated dispenser block can include a heated fuel material line and a control solenoid valve.

In one aspect of an embodiment, heating or cooling functionality provided by a dispenser heater can be distributed to other heating and/or cooling components, such as a heat source associated with each fuel material source, and a heat source associated with respective associated supply lines from the fuel material source to respective dispensers.

In the embodiment shown in FIG. 1, the one or more dispensers 104A-104N and associated nozzles 128A-128N can be manipulated with respect to the platform 106 to form an initial fuel material layer on the platform 106. In certain embodiments, the platform 106 can be manipulated in a longitudinal, lateral and/or axial direction as additional fuel material is successively disposed onto the initial fuel material layer and/or successive fuel material layers previously dispensed on the platform 106. In certain embodiments, each dispenser 104A-104N and/or associated nozzle 128A-128N can likewise be manipulated in a longitudinal, lateral and/or axial direction with respect to the platform 106 as additional fuel material is successively disposed onto the initial fuel material layer and/or successive fuel material layers previously dispensed on the platform 106. Further, in certain embodiments, the platform 106 and/or dispensers 104A-104N can be rotated as additional fuel material is successively disposed onto the initial fuel material layer and/or successive fuel material layers previously dispensed on the platform 106. In any instance, coordinated control of the dispensers 104A-104N, associated nozzles 128A-128N, dispenser motors 110A-110N, dispenser heaters 112A-112N and/or platform 106 can facilitate successively disposing or dispensing additional fuel material onto the initial fuel material layer and/or successive fuel material layers in relatively small amounts, and in certain embodiments, to account for fuel material shrinkage.

Even though a multiple dispensers, dispenser motors, dispenser heaters, nozzles, and fuel material sources are shown in FIG. 1, in certain other embodiments, a single dispenser, dispenser motor, dispenser heater, nozzle, and fuel material source for dispensing the fuel material can be utilized. Speed, control, efficiency, cost, material and fuel material selection and compatibility, and other considerations may affect the number of dispensers and associated components used to dispense at least one fuel material as well as how the relative movement of the dispensers and the platform is achieved. In any instance, embodiments of the invention can dispense at least one fuel material with respect to the platform 106.

In one embodiment, one or more dispensers similar to 104A-104N can utilize multiple fuel sources, similar to 108A-108N, and/or may utilize multiple nozzles, similar to 128A-128N, to dispense multiple fuel materials with respect to the platform 106 to either form an initial fuel material layer on the platform 106 or to successively dispose one or more additional fuel materials onto the initial fuel material layer and/or successive fuel material layers previously dispensed on the platform 106. In this embodiment, a system such as 100 may switch between multiple fuel sources, dispensers, and nozzles, as needed to form an initial fuel material layer on the platform 106 or to successively dispose one or more additional fuel materials onto the initial fuel material layer and/or successive fuel material layers previously dispensed on the platform 106. For example, using this embodiment, a system such as 100 can form a fuel grain apparatus with different fuel material burning properties depending upon the region of the fuel grain apparatus. In this instance, a fuel grain apparatus could have a relatively high energy, fast burning fuel in the central portion of the fuel grain apparatus, and a relatively less energetic, slower burning fuel material adjacent to the outer portion of the fuel grain apparatus.

In one aspect of an embodiment, the platform can be considered as one axis of a Cartesian coordinate system, where the one or more dispensers and/or associated nozzles can be moved in the other two orthogonal axes. In yet another embodiment, a non-Cartesian robot, such as a hexapod, can be used with the dispensers and dispensing nozzle.

In one embodiment, a curing device may interact with the at least one fuel material to suitably cure the at least one fuel material after being dispensed onto or with respect to the platform 106. For example, a curing device may include a heating and/or cooling element to increase or decrease the temperature of at least one fuel material. The curing device may selectively heat and/or cool certain portions of the at least one fuel material forming a fuel grain apparatus, or in other instances, may attempt to heat or cool the entirety of the at least one fuel material forming a fuel grain apparatus. In another embodiment, a curing device may apply a substance or combination of substances to suitably cure the at least one fuel material forming a fuel grain apparatus. In yet another embodiment, a curing device may apply a change in environmental or ambient condition, such as change in pressure or exposure to certain radiation wavelength, to suitably cure the at least one fuel material forming a fuel grain apparatus.

In the embodiment illustrated in FIG. 1, at least one user may operate the computer, for example 102, by inputting or selecting a particular port shape, fuel grain apparatis shape, and fuel material type from a user interface, and in some instances, making available at least one fuel material source, such as 108A, to the system 100. The computer 102 can execute a fuel grain fabrication application program, such as 120, or other sets of fuel grain fabrication instructions to facilitate fabricating a fuel grain apparatus. The computer 102 can control any number of system components such as one or more dispensers 104A-104N and platform 106 during execution of the fuel grain fabrication application program 120 or other sets of fuel grain fabrication instructions.

In the embodiment shown in FIG. 1, one or more dispensers 104A-104N can interact with the platform 106. For example, the dispenser 104A can dispense at least one fuel material onto or with respect to the platform 106 to form a fuel grain apparatus 124 with a desired port shape 126. In one embodiment, a curing device can suitably cure the at least one fuel material to form a fuel grain apparatus 124 with a desired port shape 126. A fuel grain apparatus 124 with a desired port shape 126 is thereby formed. The fuel grain apparatus 124 can then be removed from the platform 106.

Other system embodiments in accordance with the invention can include fewer or greater numbers of components and may incorporate some or all of the functionality described with respect to the system components shown in FIG. 1.

In another embodiment, a system such as 100 can be configured to read a print out of a desired fuel grain apparatus, and to form the desired fuel grain apparatus on a platform. Using an associated photodetector to read the print out of the desired fuel grain apparatus shape and port design, the system can trigger a valve associated with a fuel dispenser to dispense at least one fuel material onto the platform to form a material layer. As each line or portion of the print out is read by the photodetector, the fuel dispenser can successively dispose additional fuel material onto the material layer in small amounts, wherein the desired fuel grain and port design is formed on the platform. Other example systems in accordance with embodiments of the invention can exist.

In another embodiment, a system such as 100 can be configured to include a bath or tank of fuel material. The fuel material could be a support-type material, a granular form of a fuel material, or a granulated wax with an additive, which in any instance, can be operable for curing or consolidation upon application of heat. A nozzle, such as 128A, could be configured with a tip, which upon heating, could be manipulated through the bath or tank of fuel material to cure or otherwise consolidate the fuel material in a desired fuel grain apparatus shape with or without a relatively complex or three-dimensional port shape. In another example embodiment, the nozzle, such as 128A, could be configured to dispense an adhesive or binder into the bath or tank of the granular fuel material to achieve a similar consolidation of the fuel material into a desired fuel grain apparatus shape with or without the relatively complex three-dimensional port shape. In certain exemplary embodiments, the fuel material could also be a rubber compound. Other example systems in accordance with embodiments of the invention can exist.

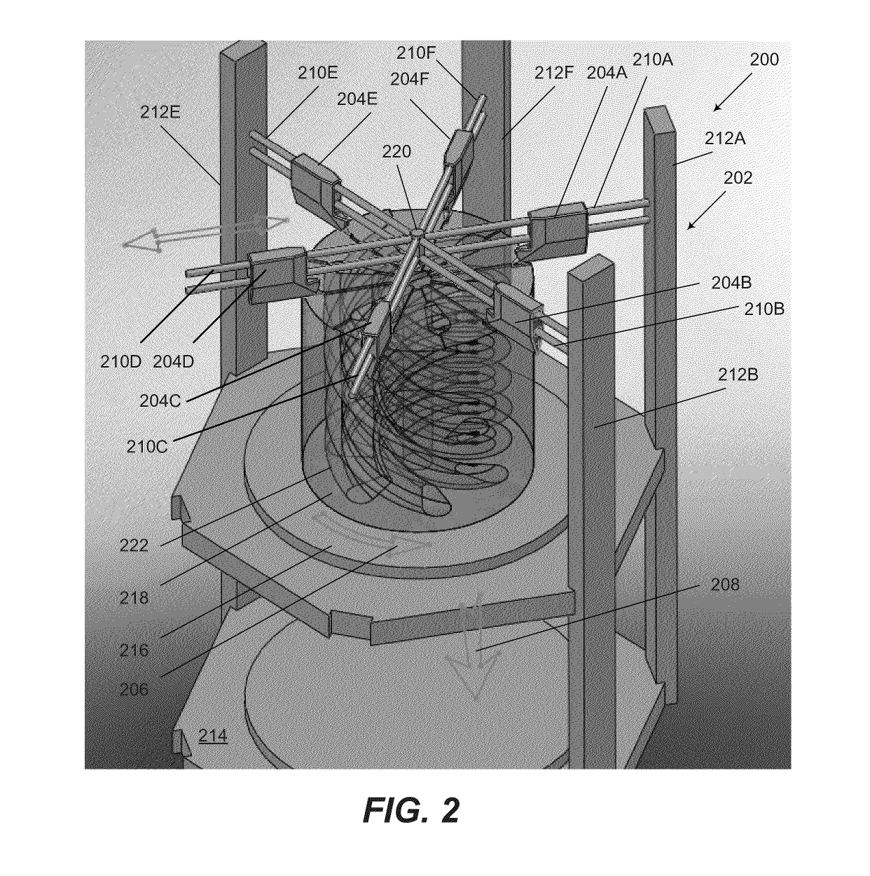

FIG. 2 illustrates perspective view of an example fuel grain fabrication system and apparatus in accordance with certain embodiments of the invention. As shown in FIG. 2, a fuel grain fabrication system 200 can include a platform 202 and a plurality of dispensers 204A-204F. The plurality of dispensers 204A-204F shown by way of example in FIG. 2 illustrates six dispensers but fewer or greater numbers of dispensers can exist in accordance with other embodiments of the invention. A portion of the platform 202 can be operable to rotate in at least one direction 206, and move in at least one axial or longitudinal direction 208. An associated motor, such as 114 in FIG. 1, can facilitate rotating and/or manipulating a particular portion of the platform 202 as needed. The plurality of dispensers 204A-204F can be arranged on a respective plurality of supports 210A-210F mounted with respect to the platform 202. Similar to the dispensers 104A-104N in FIG. 1, the plurality of dispensers 204A-204F in this embodiment can include one or more associated and respective nozzles similar to 128A-128N for dispensing at least one fuel from at least one fuel source similar to 108A-108N. In the example shown, each of the supports 210A-210F can mount to a respective substantially vertical platform support 212A-212F, which in turn mount to a base platform 214. Note that supports 210C and 210D are not shown mounted to respective vertical platform supports 212D, 212E since these vertical platform supports are omitted from FIG. 2 for ease of viewing the apparatus. A movable and rotatable plate 216 associated with the platform can be rotated and/or manipulated between the base platform 214 and the plurality of supports 210A-210F and associated plurality of dispensers 204A-204F. The movable and rotatable plate 216 is operable to receive fuel material from the dispensers 204A-204F and to support a fuel grain apparatus such as 218 formed thereon.

Each of the plurality of dispensers 204A-204F can be operable to move with respect to the respective supports 210A-210F, in particular, between a central vertical axis 220 and the adjacent vertical platform support 212A-212F. Furthermore, each of the respective supports 210A-210F can be operable to move axially or longitudinally with respect to and along the central vertical axis towards the movable and rotatable plate 216. The plurality of dispensers 204A-204F can include an associated a dispenser motor, such as 110A-110N, and a dispenser heater, such as 112A-112N in FIG. 1. Further, each dispenser 204A-204F can be connected or can otherwise receive fuel for dispensing on the platform from a respective fuel material source such as 108A-108N, or from a single fuel material source. When instructed by a computer or processor similar to 102 or 116 in FIG. 1, each of the plurality of dispensers 204A-204F can receive an amount of fuel material from a fuel material source 108A-108N, and dispense the amount of fuel material on the movable and rotatable plate 216 to form an apparatus, such as fuel grain apparatus 218, with a desired port shape, such as 222, in accordance with an embodiment of the invention. In an alternative embodiment of the system of FIG. 2, a non-Cartesian robot, such as, for example, a hexapod, can be used and can have dispensers and/or nozzles operably coupled to the non-Cartesian robot to dispense the fuel material on the plate 216. In certain of these alternative embodiments, the dispenser can be a non-Cartesian robot having one or more nozzles fluidicly coupled to a source of one or more types of fuel material.

In the embodiment shown in FIG. 2, the plurality of dispensers 204A-204N can be manipulated with respect to the movable and rotatable plate 216 to form an initial fuel material layer on the plate 216. In certain embodiments, the plate 216 can be manipulated in a longitudinal, lateral and/or axial direction as additional fuel is successively disposed onto the initial fuel material layer and/or successive fuel material layers previously dispensed on the plate 216. In certain embodiments, the plurality of dispensers 204A-204N and associated supports 210A-210F can be manipulated in a longitudinal, lateral and/or axial direction with respect to the plate 216 as additional fuel material is successively disposed onto the initial fuel material layer and/or successive fuel material layers previously dispensed on the plate 216. Further, in certain embodiments, the plate 216 and/or plurality of dispensers 204A-204N can be rotated as additional fuel material is successively disposed onto the initial fuel material layer and/or successive fuel material layers previously dispensed on the plate 216. In any instance, coordinated control of the plurality of dispensers 204A-204N, associated dispenser motors and dispenser heaters, and/or the plate 216 can facilitate successively disposing or dispensing additional fuel material onto the initial fuel material layer and/or successive fuel material layers in relatively small amounts, and in certain embodiments, to account for fuel material shrinkage. A fuel grain fabrication program similar to 120 in FIG. 1 or set of fuel grain fabrication instructions can facilitate coordinated control between various components of the system 200.

In one embodiment, one or more dispensers similar to 204A-204N can utilize multiple fuel sources, similar to 108A-108N, and/or may utilize multiple nozzles, similar to 128A-128N, to dispense multiple fuel materials with respect to the plate 216 to either form an initial fuel material layer on the plate 216 or to successively dispose one or more additional fuel materials onto the initial fuel material layer and/or successive fuel material layers previously dispensed on the plate 216. In this embodiment, a system such as 200 may switch between multiple fuel sources, dispensers, and nozzles, as needed to form an initial fuel material layer on the plate 216 or to successively dispose one or more additional fuel materials onto the initial fuel material layer and/or successive fuel material layers previously dispensed on the plate 216. For example, using this embodiment, a system such as 200 can form a fuel grain apparatus with different fuel material burning properties depending upon the region of the fuel grain apparatus. In this instance, a fuel grain apparatus could have a relatively high energy, fast burning fuel material in the central portion of the fuel grain apparatus, and a relatively less energetic, slower burning fuel material adjacent to the outer portion of the fuel grain apparatus.

In the embodiment shown in FIG. 2, the desired port shape 222 can include one or more relatively complex or three-dimensional shapes such as at least one non-longitudinal feature 204, a helical shape, a concentric disk shape, a series of anteriorally linked disk shapes, a geometric shape with at least one undercut feature, a geometric shape with at least one overhang feature, or a three-dimensional geometric shape with at least one non-longitudinal feature.

Other system and apparatus embodiments in accordance with the invention can include fewer or greater numbers of components and may incorporate some or all of the functionality described with respect to the system and apparatus components shown in FIG. 2.

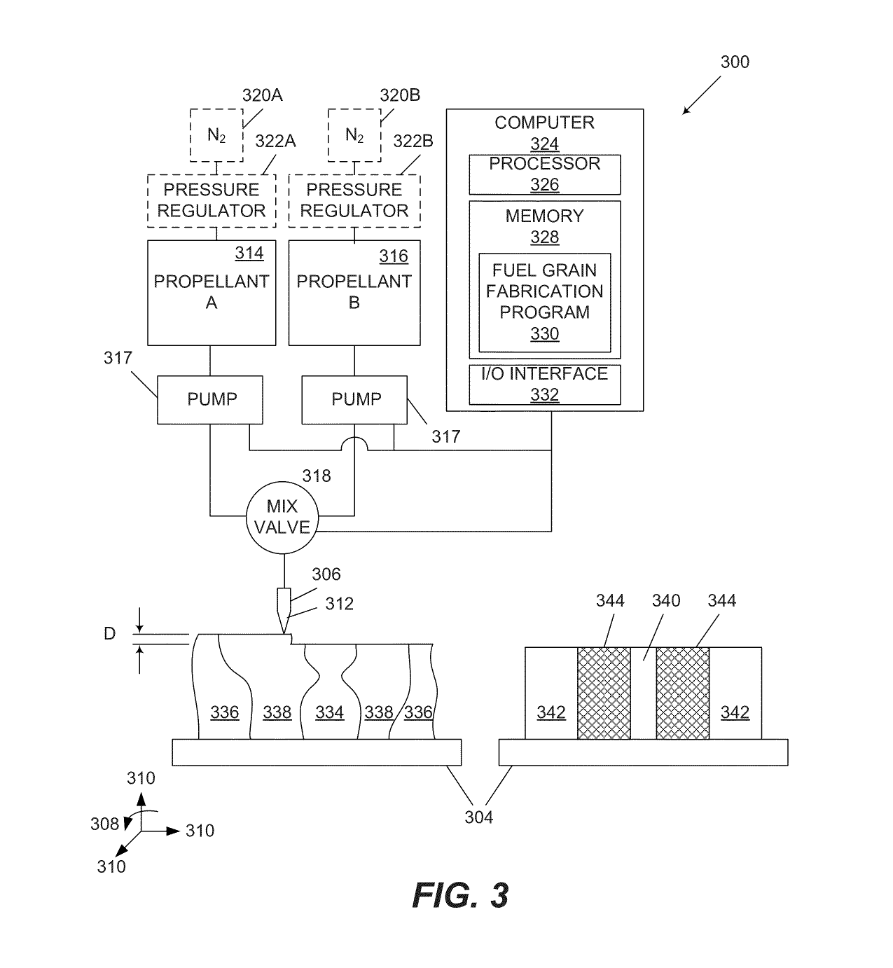

FIG. 3 illustrates another example system and apparatus in accordance with an embodiment of the invention. A schematic view of an example fuel grain fabrication system 300 and fuel grain apparatus 302A, 302B in accordance with certain embodiments of the invention is shown in FIG. 3. Similar to the fuel grain fabrication system 100 of FIG. 1, the system 300 can include a platform, such as 304, and at least one dispenser, such as 306. The dispenser 306 shown by way of example in FIG. 3 illustrates a single dispenser but fewer or greater numbers of dispensers can exist in accordance with other embodiments of the invention. The dispenser 306 in FIG. 3 can be operable to dispense multiple fuel materials on the platform 304. A portion of the platform 304 can be operable to rotate in at least one direction 308, and move in at least one axial, lateral, or longitudinal direction 310. In certain embodiments, the platform 304 and the dispenser 306 may provide multiple degrees of motion relative to one another by any combination of one or the other providing axial, longitudinal, lateral, and rotational movement. An associated motor, similar to 114 in FIG. 1, can facilitate rotating and/or manipulating a particular portion of the platform 304 as needed. Similar to the dispensers 104A-104N in FIG. 1, the dispenser 306 in this embodiment can include a nozzle 312 similar to 128A for dispensing at least one fuel material from at least one fuel material source 314, 316 similar to 108A-108N. In the example shown, the dispenser 306 and associated nozzle 312 can be connected to multiple fuel material sources, such as 314 and 316. Each of the fuel material sources 314, 316 can be, but is not limited to, a fuel, fuel material, an additive, a mixture, or any substance that can be mixed with any of the foregoing. At least one gear pump 317 can control the relative amounts supplied from either or both of the fuel material sources 314, 316 to the dispenser 306 and associated nozzle 312. Depending on the type of fuel material source, each fuel material source 314, 316 may be pressurized, such as with nitrogen gas source 320A, 320B, and may include another delivery or supply mechanism, such as a pressure regulator 322A, 322B, a screw drive, piston, or other electrical device, mechanical device, or combination thereof. Alternatively, as opposed to pressure-driven dispensing with the gas sources 320A and 320B and regulators 322A and 322B, a gear pump, such as a metering pump or a piston pump, can be utilized as a positive displacement pump 317. The positive-displacement pump may sweep out a specific volume of material each cycle, and in certain embodiments, may eliminate the need for the mix valve 318. In an alternative embodiment of the system of FIG. 3, a non-Cartesian robot, such as, for example, a hexapod, can be used and can have dispensers, nozzles, and/or other components described above operably coupled to the non-Cartesian robot and work cooperatively with the platform 304 to dispense the one or more types of fuel material. In certain of these alternative embodiments, the dispenser can be a non-Cartesian robot having one or more nozzles fluidicly coupled to a source of one or more types of fuel material.

Similar to the embodiments shown in FIGS. 1 and 2, the system 300 can be controlled by a computer 324 with a processor 326, memory 328, fuel grain fabrication program 330, and I/O interface 332. These components 324-332 are similar to those described in FIG. 1 as 102, and 116-122. When instructed by the computer 324 or processor 326, the dispenser 306 can receive an amount of fuel from either or both fuel material sources 314, 316, and dispense the amount of fuel on the movable and rotatable platform 304 to form an apparatus, such as fuel grain 302A, with a desired port shape in accordance with an embodiment of the invention.

Similar to the embodiments shown in FIGS. 1 and 2, the dispenser 306 can be manipulated with respect to the movable and rotatable platform 304 to form an initial fuel material layer on the platform 304. In certain embodiments, the platform 304 can be manipulated in a longitudinal, lateral and/or axial direction as additional fuel material is successively disposed onto the initial fuel material layer and/or successive fuel material layers previously dispensed on the plate 216. In certain embodiments, the dispenser 306 can be manipulated in a longitudinal, lateral and/or axial direction with respect to the platform 304 as additional fuel material is successively disposed onto the initial fuel material layer and/or successive fuel material layers previously dispensed on the platform 304. Further, in certain embodiments, the platform 304 and/or dispenser 306 can be rotated as additional fuel material is successively disposed onto the initial fuel material layer and/or successive fuel material layers previously dispensed on the platform 304. In any instance, coordinated control of the dispenser 306 and/or the platform 304 can facilitate successively disposing or dispensing additional fuel material onto the initial fuel material layer and/or successive fuel material layers in relatively small amounts, and in certain embodiments, to account for fuel material shrinkage. By way of example, a thickness of an example material layer is illustrated in FIG. 3 as D. The fuel grain fabrication program 330, similar to 120 in FIG. 1, or set of fuel grain fabrication instructions can facilitate coordinated control between various components of the system 300.

In one embodiment, one or more dispensers, similar to 306, can utilize multiple fuel sources, similar to 314, 316, and/or may utilize multiple nozzles, similar to 312, to dispense multiple fuels with respect to the platform 304 to either form an initial fuel material layer on the platform 304 or to successively dispose one or more additional fuel materials onto the initial fuel material layer and/or successive fuel material layers previously dispensed on the platform 304. In this embodiment, a system such as 300 may switch between multiple fuel material sources, dispensers, and nozzles, as needed to form an initial fuel material layer on the platform 304 or to successively dispose one or more additional fuel materials onto the initial fuel material layer and/or successive fuel material layers previously dispensed on the platform 304. For example, using this embodiment, a system such as 300 can form a fuel grain apparatus with different fuel material burning properties depending upon the region of the fuel grain apparatus. In this instance, a fuel grain apparatus could have a relatively high energy, fast burning fuel material in the central portion of the fuel grain apparatus, and a relatively less energetic, slower burning fuel material adjacent to the outer portion of the fuel grain apparatus.

In the embodiment shown in FIG. 3, a desired fuel grain apparatus, such as 302A, can have a desired port shape 334, which can include one or more relatively complex shapes such as at least one non-longitudinal feature 204, a helical shape, a concentric disk shape, a series of anteriorially linked disk shapes, a geometric shape with at least one undercut feature, a geometric shape with at least one overhang feature, or a three-dimensional geometric shape with at least one non-longitudinal feature. Further, different portions of the fuel grain apparatus 302A can include different fuel material mixtures. For example, an outer portion 336 of the fuel grain apparatus 302A can include a first component mixture with a relatively higher amount of propellant A 314 than propellant B 316, and an inner portion 338 of the fuel grain apparatus 302A can include a second component mixture with relatively lower amount of propellant A 314 than propellant B 316.

Another example fuel grain apparatus 302B is shown in FIG. 3 adjacent to fuel grain apparatus 302A. In this example, the fuel grain apparatus 302B can have a desired port shape 340, which can include one or more relatively complex shapes such as at least one non-longitudinal feature 204, a helical shape, a concentric disk shape, a series of anteriorially linked disk shapes, a geometric shape with at least one undercut feature, a geometric shape with at least one overhang feature, or a three-dimensional geometric shape with at least one non-longitudinal feature. Further, different portions of the fuel grain apparatus 302B can include different fuel material mixtures. For example, an outer portion 340 of the fuel grain apparatus 302A can include a first component mixture with a relatively high regression rate and comprising mostly propellant A 314, and an inner portion 344 of the fuel grain apparatus 302B can include a second component mixture with a relatively lower regression rate comprising mostly propellant B 316.

Other system and apparatus embodiments in accordance with the invention can include fewer or greater numbers of components and may incorporate some or all of the functionality described with respect to the system and apparatus components shown in FIG. 3.

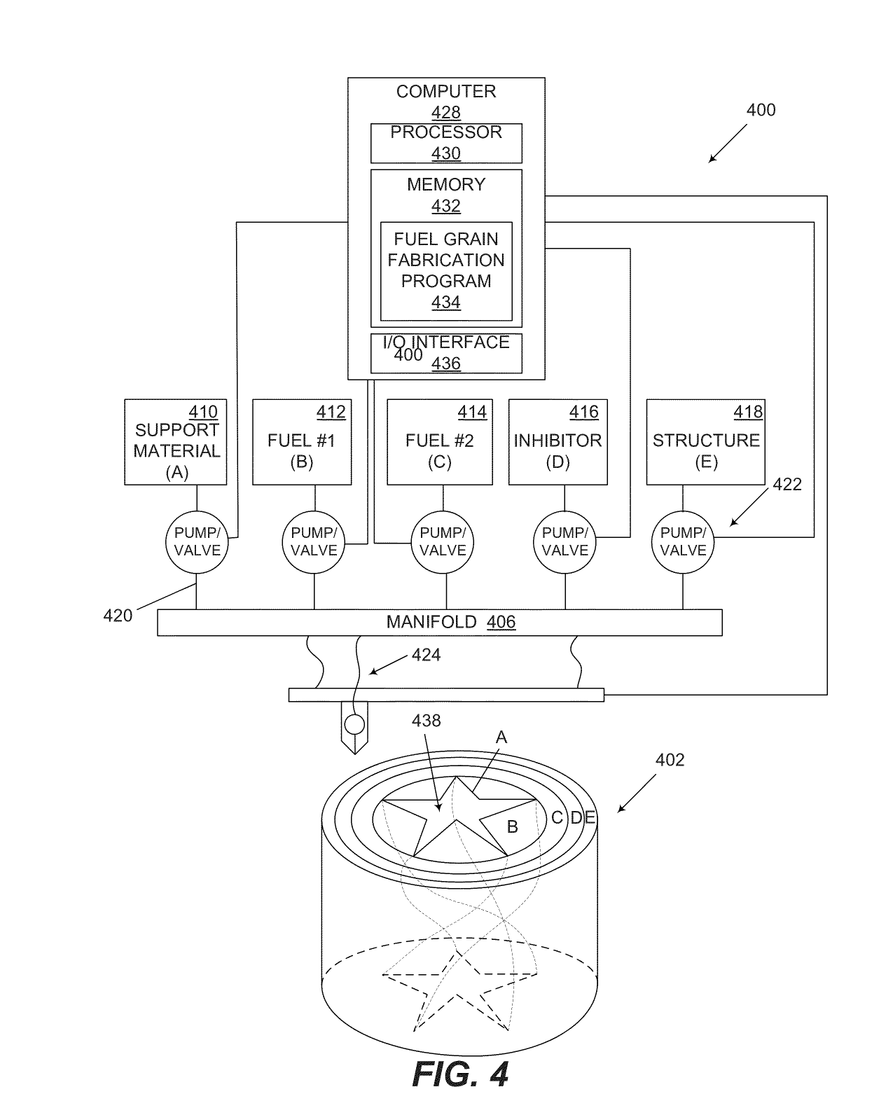

FIG. 4 illustrates another example system and apparatus in accordance with an embodiment of the invention. A schematic view of an example fuel grain fabrication system 400 and fuel grain apparatus 402 in accordance with certain embodiments of the invention is shown in FIG. 4. In the embodiment of FIG. 4, the system 400 can include a dispenser 404 operable to move in horizontal and axial directions. In any instance, the dispenser 404 shown by way of example in FIG. 4 illustrates a single dispenser but fewer or greater numbers of dispensers can exist in accordance with other embodiments of the invention. The dispenser 404 in FIG. 4 can be operable to move with respect to a heated dispensing carriage 406 and associated manifold 408. The dispenser 404 can dispense multiple fuel grain materials received from one or more material sources, for example, 410, 412, 414, 416, and 418. Each of the material sources 410, 412, 414, 416, and 418 can provide a respective material, such as a support material, a fuel, an additive, a mixture, an inhibitor, or a structural material, via one or more respective heated lines 420 to the manifold 408. Respective flow control devices 422, which may comprise one or more positive-displacement pumps and/or one or more valves, can control the material flow through each of the heated lines 420. One or more flexible heated lines 424 from the manifold 408 can provide the fuel grain materials to the dispenser 404.

In certain embodiments similar to the fuel grain fabrication system 100 of FIG. 1, the system 400 can include a platform, similar to 106, which may be operable to move in either or both horizontal and axial directions. For such embodiments, a portion of the platform can be operable to rotate in at least one direction, and move in at least one axial or longitudinal direction. An associated motor, similar to 114 in FIG. 1, can facilitate rotating and/or manipulating a particular portion of the platform as needed.

In any instance, similar to the dispensers 104A-104N in FIG. 1, the dispenser 404 in the embodiment in FIG. 4 can include a nozzle 426, similar to 128A, for dispensing at least one fuel grain material from at least one material source 410, 412, 414, 416, and 418 similar to 108A-108N. At least one valve associated with the dispenser 404 and/or associated nozzle 426 can control the relative amount of fuel grain material dispensed from the dispenser 404 and/or associated nozzle 426. In an alternative embodiment of the system of FIG. 4, a non-Cartesian robot, such as, for example, a hexapod, can be used and can have dispensers, nozzles, heated dispensing carriage and/or other components described above operably coupled to the non-Cartesian robot and work cooperatively with the optional platform to dispense the one or more types of fuel material. In certain of these alternative embodiments, the dispenser can be a non-Cartesian robot having one or more nozzles fluidicly coupled to a source of one or more types of fuel material.

Similar to the embodiments shown in FIGS. 1-3, the system 400 can be controlled by a computer 428 with a processor 430, memory 432, fuel grain fabrication program 434, and I/O interface 436. These components 428-436 are similar to those described in FIG. 1 as 102, and 116-122. When instructed by the computer 428 or processor 430, the dispenser 404 can receive an amount of fuel grain material from one or more material sources 410, 412, 414, 416, and 418, and dispense the amount of fuel grain material to form an apparatus, such as fuel grain apparatus 402, with a desired port shape in accordance with an embodiment of the invention.

Similar to the embodiments shown in FIGS. 1-3, the dispenser 404 can be manipulated to form an initial fuel material layer. In certain embodiments, the dispenser 404 can be manipulated in a longitudinal, lateral and/or axial direction as additional fuel grain material is successively disposed onto the initial fuel grain material layer and/or previously dispensed successive fuel grain material layers. In certain embodiments, the dispenser 404 can be manipulated in a longitudinal, lateral and/or axial direction with respect to a platform as additional fuel grain material is successively disposed onto the initial fuel grain material layer and/or previously dispensed successive fuel grain material layers on the platform. Further, in certain embodiments, the platform and/or dispenser 404 can be rotated as additional fuel grain material is successively disposed onto the initial fuel grain material layer and/or successive fuel grain material layers previously dispensed on the platform. In any instance, coordinated control of the dispenser 404 and/or the platform can facilitate successively disposing or dispensing additional fuel grain material onto the initial fuel grain material layer and/or successive fuel grain material layers in relatively small amounts, and in certain embodiments, to account for fuel grain material shrinkage. The fuel grain fabrication program 434, similar to 120 in FIG. 1, or set of fuel grain fabrication instructions can facilitate coordinated control between various components of the system 400.

In one embodiment, one or more dispensers, similar to 404, can utilize multiple fuel sources, similar to 410, 412, 414, 416, and 418, and/or may utilize multiple nozzles, similar to 426, to dispense multiple fuel grain materials to either form an initial fuel grain material layer or to successively dispose one or more additional fuel grain materials onto the initial fuel grain material layer and/or successive fuel grain material layers. In this embodiment, a system such as 400 may switch between multiple material sources, dispensers, and nozzles, as needed to form an initial fuel grain material layer or to successively dispose one or more additional fuel grain materials onto the initial fuel grain material layer and/or previously dispensed successive fuel grain material layers. For example, using this embodiment, a system such as 400 can form a fuel grain apparatus with different fuel burning properties depending upon the region of the fuel grain apparatus. In this instance, a fuel grain apparatus could have a relatively high energy, fast burning fuel in the central portion of the fuel grain apparatus, and a relatively less energetic, slower burning fuel adjacent to the outer portion of the fuel grain apparatus.

In the embodiment shown in FIG. 4, a desired fuel grain apparatus, such as 402, can have a desired port shape 438, which can include one or more relatively complex or three-dimensional shapes such as at least one non-longitudinal feature, a helical shape, a concentric disk shape, a series of anteriorially linked disk shapes, a geometric shape with at least one undercut feature, a geometric shape with at least one overhang feature, or a three-dimensional geometric shape with at least one non-longitudinal feature. Further, different portions of the fuel grain apparatus 402 can include different fuel grain material mixtures. For example, an inner portion A could be formed using a support-type material, and various adjacent intermediate portions B, C, D, and outer portions E can be formed in a fuel grain apparatus 402.

Other system and apparatus embodiments in accordance with the invention can include fewer or greater numbers of components and may incorporate some or all of the functionality described with respect to the system and apparatus components shown in FIG. 4.

FIGS. 6-10 illustrate other example apparatus in accordance with certain embodiments of the invention. FIGS. 6 and 7 illustrate various views of an apparatus such as a fuel grain with a spiral-shaped port in accordance with an embodiment of the invention. In FIG. 6, a cutaway perspective view of an example fuel grain 600 is shown. A spiral-shaped port 602 begins at an upper portion of the fuel grain 600, continues downward through the body 604 of the fuel grain 600, and terminates in a lower conically-shaped port section 606. In the embodiment shown in FIGS. 6 and 7, the spiral-shaped port 602 includes approximately 9-10 circular-shaped loops 608 formed in the fuel grain body 604. FIG. 7 illustrates a hidden perspective view of the spiral-shaped port 602 and loops 608 within the fuel grain 600 and associated body 604. Other embodiments of an apparatus or fuel grain apparatus can include any number of spiral-shaped ports with a greater or smaller circumference, greater or fewer numbers of loops, or with different shaped loops or ports.

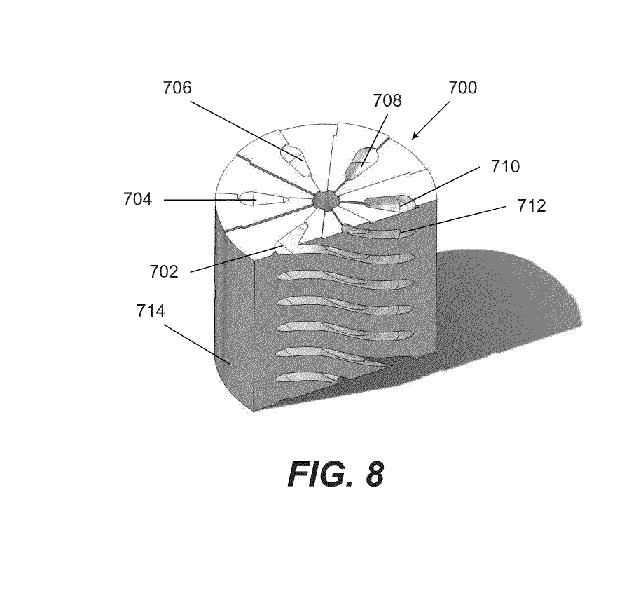

FIG. 8 illustrates another apparatus such as a fuel grain apparatus with multiple spiral-shaped ports in accordance with an embodiment of the invention. In FIG. 8, a cutaway perspective view of another example fuel grain apparatus 700 is shown. Six spiral-shaped ports 702, 704, 706, 708, 710, 712 continue downward through the body 714 of the fuel grain 700, and each terminates in a lower portion of the body 714. In the embodiment shown in FIG. 8, each of the spiral-shaped ports 702, 704, 706, 708, 710, 712 includes multiple circular-shaped loops formed in the fuel grain body 714. Other embodiments of an apparatus or fuel grain apparatus can include any number of spiral-shaped ports with a greater or smaller circumference, greater or fewer numbers of loops, with different shaped loops or ports, or with intersecting ports or loops.

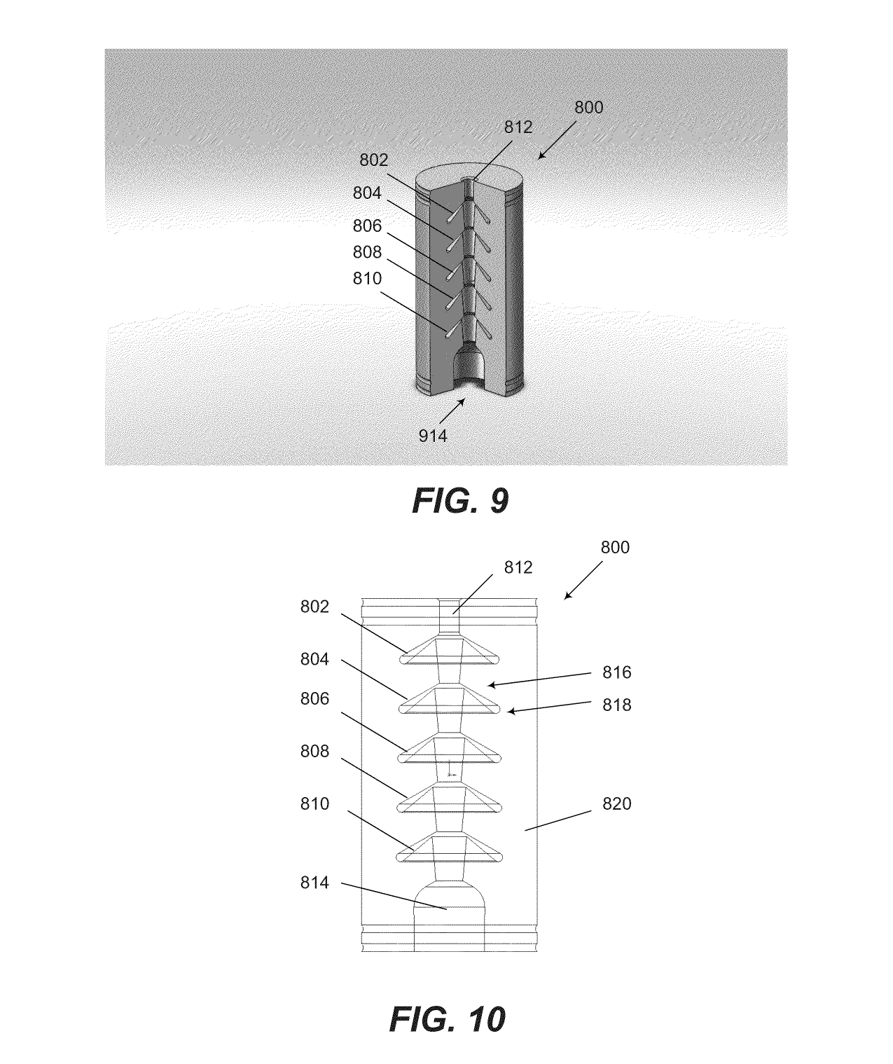

FIGS. 9 and 10 illustrate various views of an apparatus such as a fuel grain apparatus with multiple stacked disk-shaped ports in accordance with an embodiment of the invention. In FIG. 9, a cutaway perspective view of another example fuel grain apparatus 800 is shown. A conical disc-shaped port 802 begins at an upper portion of the fuel grain apparatus 800, and four successively formed conical disk-shaped ports 804, 806, 808, 810 are positioned beneath the upper conical disk-shaped port 804. A centrally positioned narrow, cylindrically-shaped port 812 links the conical disk-shaped ports 802, 804, 806, 808, 810 together, and terminates in a lower knob-shaped port section 814. In the embodiment shown in FIGS. 9 and 10, each conical disk-shaped port 802, 804, 806, 808, 810 includes a circumferential disk with a relatively narrow upper portion 816 and a relatively broad lower portion 818. FIG. 10 illustrates a hidden side view of the conical disk-shaped ports 802, 804, 806, 808, 810 within the fuel grain 800 and associated body 820. Other embodiments of an apparatus or fuel grain apparatus can include any number of conical disk-shaped ports with a greater or smaller circumference, greater or fewer numbers of conical disks, or with different shaped disks or ports.

In certain exemplary embodiment, such as those illustrated in FIGS. 6-10, a pre-combustion chamber (or vaporization chamber) can be placed between the inlet and the fuel grain to allow for vaporization of liquid oxidizer and to provide even distribution into multiple input ports. According to certain embodiments of the invention, such as those illustrated in FIGS. 6-10, a post-combustion chamber may be included between the fuel grain and the nozzle to allow a more complete reaction of oxidizer gas and any residual or un-burned fuel. In addition, certain embodiments may include both a pre-combustion and a post-combustion chamber.

One skilled in the art may recognize the applicability of embodiments of the invention to other environments, contexts, and applications. One will appreciate that components of the systems 100, 200, 300, 400 shown in and described with respect to FIGS. 1, 2, 3, and 4; and apparatus, such as fuel grain apparatus 218, 302A, 302B, 402, and 600 shown in and described with respect to FIGS. 2, 3, 4 and 6-10 are provided by way of example only. Numerous other operating environments, system architectures, and apparatus configurations are possible. Accordingly, embodiments of the invention should not be construed as being limited to any particular operating environment, system architecture, or apparatus configuration.

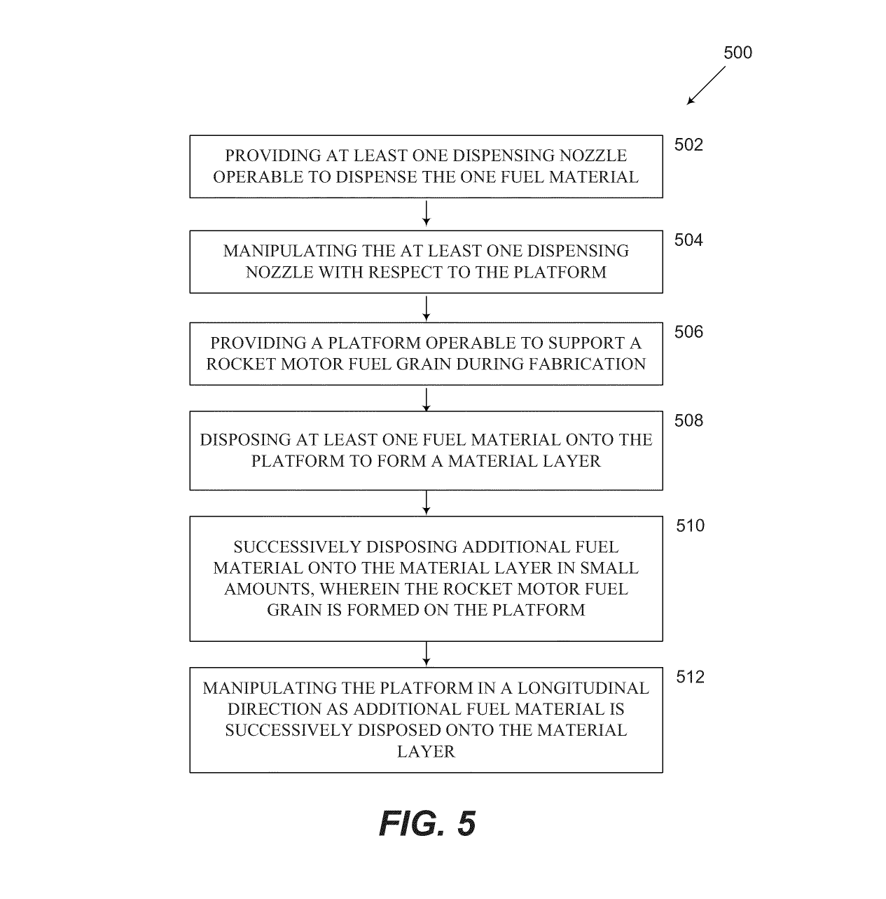

Embodiments of a system, such as 100, 200, 300, and 400, can facilitate fabricating hybrid rocket motor fuel grains. Improvements in fabricating hybrid rocket motor fuel grains, can be achieved by way of implementation of various embodiments of the systems 100, 200, 300, 400; the apparatus such as fuel grain apparatus 218 described in FIG. 2, 302A and 302B in FIGS. 3, and 402 in FIG. 4; and methods described herein. Example methods and processes which can be implemented with the example systems 100, 200, 300, 400 to make certain example fuel grain apparatus such as 218, 600, 700, 800 are described by reference to FIG. 5.

FIG. 5 illustrates an example method of fabricating a rocket motor fuel grain in accordance with an embodiment of the invention. The method 500 can be implemented by a system such as 100, 200, 300, or 400.

The method 500 begins at block 502, at least one dispensing nozzle operable to dispense the one fuel material is provided. In the embodiment shown in FIG. 5, at least one nozzle similar to 128A in FIG. 1 and associated with at least one of a plurality of dispensers such as 204A-204N in FIG. 2 can be provided to dispense at least one fuel material from a fuel material source similar to 108A in FIG. 1. In an alternative embodiment, the one or more dispensing nozzles are operably coupled to a non-Cartesian robot, such as, for example, a hexapod, to dispense the one or more types of fuel material. In certain of these alternative embodiments, the dispenser can be a non-Cartesian robot having one or more nozzles fluidicly coupled to a source of one or more types of fuel material.

Block 502 is followed by block 504, in which the at least one dispensing nozzle is manipulated with respect to a platform. In the embodiment shown in FIG. 5, at least one nozzle similar to 128A can be manipulated by an associated dispenser motor similar to 110A with respect to a platform such as 202 or a movable and rotatable plate such as 216.

Block 504 is followed by block 506, in which a platform operable to support a rocket motor fuel grain apparatus during fabrication is provided. In the embodiment shown in FIG. 5, a platform such as 202 or a movable and rotatable plate such as 216 can be provided, wherein the platform 202 or plate 216 can support a rocket motor fuel grain apparatus being fabricated thereon. An example fuel grain apparatus is shown as 218 in FIG. 2 with a desired port shape 222.

Block 506 is followed by block 508, in which at least one fuel material is disposed onto the platform to form a material layer. In the embodiment shown in FIG. 5, the at least one nozzle similar to 128A can dispense a relatively small portion of at least one fuel material from the fuel material source such as 108 onto the platform 202 or plate 216 to form an initial material layer.

In one aspect of one embodiment, the at least one dispensing nozzle can be manipulated in a lateral direction with respect to the platform or plate as additional fuel material is successively disposed onto the initial material layer.

In one aspect of one embodiment, the platform or plate can be rotated as additional fuel material is successively disposed onto the initial material layer.

In one aspect of one embodiment, successively disposing additional fuel material onto the initial material layer in relatively small amounts is controlled by a computer processor.

In one aspect of one embodiment, the at least one dispensing nozzle can include a plurality of dispensing nozzles, wherein each of the plurality of dispensing nozzles is heated and controlled by a computer processor.

In one aspect of one embodiment, the at least one fuel material can include, but is not limited to, paraffin wax, hydroxyl terminated polybutadiene (HTPB), a hybrid rocket motor fuel, a composite solid rocket motor fuel, or any combination thereof.

Block 508 is followed by block 510, in which additional fuel material is successively disposed onto the material layer in small amounts, wherein the rocket motor fuel grain apparatus is formed on the platform. In the embodiment shown in FIG. 5, the at least one nozzle similar to 128A can successively dispense one or more relatively small portions of the fuel material from the fuel material source such as 108 onto the initial material layer previously dispensed on the platform 202 or plate 216. In certain embodiments, fuel material shrinkage due to cooling and/or curing of the fuel material can be accounted for when determining the relatively small portions of the fuel material to initially dispense and successively dispense.

Block 510 is followed by block 512, in which the platform is manipulated in a longitudinal direction as additional fuel material is successively disposed onto the material layer. In the embodiment shown in FIG. 5, the platform such as 202 or a movable and rotatable plate such as 216 can be manipulated by at least one platform motor such as 114 in FIG. 1, wherein the platform 202 or plate 216 is manipulated in a longitudinal direction as additional fuel material is successively dispensed on the initial material layer. In this manner, a fuel grain apparatus such as 218 can be fabricated with a desired three-dimensional port shape such to 222.

After block 512, the method 500 ends.

Embodiments of the invention are described above in FIG. 5 with reference to block diagrams and flowchart illustrations of systems, methods, apparatuses and computer program products. It will be understood that some or all of the blocks of the block diagrams and flowchart illustrations, and combinations of blocks in the block diagrams and flowchart illustrations, respectively, can be implemented by computer program instructions. These computer program instructions may be loaded onto a general purpose computer, special purpose computer such as a switch, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. The computer program instructions may also be loaded onto a computer or other programmable data-processing apparatus to cause a series of operational elements or steps to be performed on the computer or other programmable apparatus to produce a computer-implemented process such that the instructions that execute on the computer or other programmable apparatus provide elements or steps for implementing the functions specified in the flowchart block or blocks.

Accordingly, blocks of the block diagrams and flowchart illustrations may support combinations of means for performing the specified functions, combinations of elements for performing the specified functions, and program instruction means for performing the specified functions. It will also be understood that some or all of the blocks of the block diagrams and flowchart illustrations, and combinations of blocks in the block diagrams and flowchart illustrations, can be implemented by special purpose hardware-based computer systems that perform the specified functions, elements, or combinations of special purpose hardware and computer instructions.

Additionally, it is to be recognized that, while the invention has been described above in terms of one or more embodiments, it is not limited thereto. Various features and aspects of the above described invention may be used individually or jointly. Although the invention has been described in the context of its implementation in a particular environment and for particular purposes, its usefulness is not limited thereto and the invention can be beneficially utilized in any number of environments and implementations. Furthermore, while the methods have been described as occurring in a specific sequence, it is appreciated that the order of performing the methods is not limited to that illustrated and described herein, and that not every element described and illustrated need be performed. Accordingly, the claims set forth below should be construed in view of the full breadth of the embodiments as disclosed herein.

What is claimed is:

1. A method of fabricating a rocket motor fuel grain, the method comprising:
providing a platform operable to support a rocket motor fuel grain during fabrication;
disposing at least one fuel material onto the platform to form a material layer; and
successively disposing additional fuel material onto the material layer in small amounts, wherein the rocket motor fuel grain is formed on the platform, the rocket motor fuel grain comprising a three-dimensional port shape.

2. The method of claim 1, wherein the method further comprises:
providing at least one dispensing nozzle operable to dispense the one fuel material; and
manipulating the at least one dispensing nozzle with respect to the platform.

3. The method of claim 1, wherein the method further comprises:
manipulating the platform in a longitudinal direction as additional fuel material is successively disposed onto the material layer and, wherein the at least one dispensing nozzle can be manipulated in a lateral direction with respect to the platform as additional fuel material is successively disposed onto the material layer.

4. The method of claim 1, wherein the platform can be rotated as additional fuel material is successively disposed onto the material layer.

5. The method of claim 2, wherein the at least one dispensing nozzle comprises a plurality of dispensing nozzles, wherein each of the plurality of dispensing nozzles is heated and controlled by a computer processor.

6. The method of claim 1, wherein the at least one fuel material comprises at least one of the following: paraffin wax, an additive, a mixture of a fuel and at least one additive, or a material that shrinks upon cooling.

7. The method of claim 1, wherein the three-dimensional port shape comprises one of the following: a helical shape, a concentric disk shape, a series of anteriorially linked disk shapes, a geometric shape with at least one undercut feature, a geometric shape with at least one overhang feature, or at least one non-longitudinal feature.

8. A system for fabricating a rocket motor fuel grain, the system comprising:
a platform operable to support a rocket motor fuel grain during fabrication; and
a dispenser operable to dispense at least one fuel material onto the platform to form a rocket motor fuel grain, and further operable to be manipulated with respect to the platform;
wherein the at least one fuel material is dispensed onto the platform to form a material layer, and wherein additional fuel material is successively dispensed onto the material layer in small amounts, and the rocket motor fuel grain comprising a three-dimensional port shape.

9. The system of claim 9, wherein the dispenser comprises a non-Cartesian robot comprising at least one nozzle fluidicly coupled to a source of fuel material.

10. The system of claim 9, wherein the platform is further operable to be manipulated in a longitudinal direction as additional fuel material is successively disposed onto the material layer.

11. The system of claim 9, wherein the dispenser comprises at least one dispensing nozzle operable to be manipulated in a lateral direction with respect to the platform as additional fuel material is successively disposed onto the material layer.

12. The system of claim 9, wherein the platform is operable to be rotated as additional fuel material is successively disposed onto the material layer.

13. The system of claim 9, further comprising a computer processor operable to control dispensing the at least one fuel material onto the platform, and further operable to control dispensing additional fuel material onto the material layer in small amounts.

14. The system of claim 13, wherein the dispenser comprises a plurality of dispensing nozzles operable to be heated and controlled by the computer processor.

15. The system of claim 9, further comprising at least one motor operable to control at least one of the platform or the dispenser.

16. The system of claim 9, wherein the at least one fuel material comprises at least one of the following: paraffin wax, an additive, a mixture of a fuel and at least one additive, or a material that shrinks upon cooling.

17. The system of claim 9, wherein the three-dimensional port shape comprises one of the following: a helical shape, a concentric disk shape, a series of anteriorially linked disk shapes, a geometric shape with at least one undercut feature, a geometric shape with at least one overhang feature, or at least one non-longitudinal feature.

18. An apparatus comprising:
at least one fuel material formed by:
dispensing the at least one fuel material onto a platform to form a material layer; and
successively dispensing additional fuel material onto the material layer in small amounts, wherein at least one port shape is formed in the at least one fuel material; and
at least one three-dimensional port shape formed by the at least one fuel material.

19. The apparatus of claim 18, wherein the at least one three-dimensional port shape comprises at least one of the following: a helical shape, a concentric disk shape, a series of anteriorially linked disk shapes, a geometric shape with at least one undercut feature, a geometric shape with at least one overhang feature, or at least one non-longitudinal feature.

20. The apparatus of claim 18, wherein the at least one fuel material comprises at least one of the following: paraffin wax, an additive, a mixture of a fuel and at least one additive, or a material that shrinks upon cooling.
